(19) United States
(12) Patent Application Publication
(10) Pub. No.: US 2004/0068156 A1
(43) Pub. Date: Apr. 8, 2004

(54) Heavy metal stabilization using wet process phosphoric acids and complexing combinations, particularly for mining waste

(76) Inventor: Keith E. Forrester, Meridith, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/677,161

(22) Filed: Oct. 1, 2003

Related U.S. Application Data
(60) Provisional application No. 60/415,685, filed on Oct. 2, 2002.

(51) Int. Cl. A62D 3/00

(52) U.S. Cl. 588/256

(57) ABSTRACT

The invention pertains to a method for reducing the leaching of heavy metal from heavy metal the surface of a heavy metal bearing material or waste. The method includes contacting the heavy metal bearing material or waste with a wet process phosphoric acid, optional complexing source and optional surfactant.

### RELATED APPLICATIONS

This application claims the benefit of U.S. application Ser. No. 60/415,685 filed on Oct. 2, 2002. The entire teachings of the above applications are incorporated herein by reference.

### BACKGROUND OF THE INVENTION

The leaching of lead, As, Cu, Cd and Zn (hereinafter referred to as “heavy metals”) into the environment has been a major concern of health officials and water supply professionals for many years. In addition to concern over direct leaching heavy metals into ground waters and surface waters, regulators and professionals have also been concerned with indirect leaching of lead, As, Cu, Cd and Zn from unlined landfills which generate acidic leaching conditions due to decay of organic matter and thus high levels of heavy metals leaching potential. In response to the concern of heavy metals leaching from both water and landfill leachate borne conditions, the USEPA under direction from Congress, prepared regulations for testing, managing, and disposing of heavy metal bearing wastes. The regulations under the Resource Conservation and Recovery Act (RCRA) and Comprehensive Environmental Response, Compensation, and Liability Act (CERCLA—a.k.a. Superfund) are extensive, complex, and have great impact on industry and practices involving heavy metals. Under RCRA, heavy metal bearing wastes may be considered hazardous if failing the Toxicity Characteristic Leaching Procedure (TCLP) at 5.0 ppm, and thus required to be disposed of at a hazardous waste landfill or treatment, storage and disposal facility (TSDF). These options are very expensive, normally $200.00 per waste ton. Under CERCLA, regulators can control or require treatment of heavy metal wastes at almost any level as the states have flexibility in setting cleanup standards. Consequently, producing heavy metal bearing waste can be very expensive. Similar regulatory and remedial cost conditions exist in Japan, Switzerland, and other countries.

### SUMMARY OF THE INVENTION

The invention pertains to compositions and methods of reducing the solubility of heavy metal from a heavy metal bearing material or waste. The method comprises contacting the heavy metal bearing material or waste with a composition comprising wet process phosphoric acid, optionally in combination with complexing agents; wherein the phosphoric acid and optional complexing agent are present in the composition in amounts effective in reducing heavy metal leaching from the heavy metal bearing material or waste. In another embodiment, the composition further comprises surfactant. In one embodiment, the heavy metal leaching should be reduced to a level no more than RCRA HAZ (e.g., 5.0 ppm lead, 5.0 ppm As, 250 ppm Zn and 1.0 ppm Cd), as determined in an EPA TCLP test, performed on the heavy metal bearing material or waste or the heavy metal contaminated material that has been in contact with the heavy metal bearing material or waste, as set forth in the Federal Register, vol. 55, no. 126, pp. 26985-26998 (Jun. 29, 1990). In another embodiment, an effective reduction in lead, Cd, As, Cu and Zn leaching (e.g., to about 50 ppb) can be measured using the Simulated Precipitant Leaching Procedure (SPLP) method 1310 or other water leach test. In yet another embodiment, the heavy metal leaching will be reduced using the compositions and methods of the invention to surface water or drinking water standards.

The wet process phosphoric acid provides sources of both a phosphate (the lead stabilizing agent) and a lead, Cd, As, Cu and Zn mineral complexing agent (e.g., iron, aluminum, sulfuric acid and ferric ion) in a single composition. A source of calcium may be included (as a complexer) to allow the formation of mineral phosphate apatites of low water solubility for Pb and Cd, and higher pH values suitable with ferric arsenate and zinc and copper phosphate precipitates. The term “wet process phosphoric acids” includes phosphates produced by the wet process as known to those of skill in the art, and include merchant grade phosphoric acid such as amber phosphoric acid and green acid which retain sulfuric acid and other phosphate rock ore components. The heavy metal mineral complexing agent can be calcium, silicates, sodium silicate, lime, magnesium oxides, calcium chloride, sodium chloride, potassium chloride, vanadium, boron, iron, aluminum, sulfates, ferric sulfate, ferric chloride, potassium silicate, alum or combinations thereof. In one embodiment, the material or waste is pretreated with complexing agent (e.g., ferric chloride) to allow complex formation (e.g., ferric arsenate) prior to addition of wet process phosphoric acid.

This invention has the advantage of reducing the solubility of heavy metal prior to its generation into waste or after the material is classified as a waste. This method allows the heavy metal bearing material or waste exposed soils/materials to remain below TCLP levels and thus exempt from RCRA hazardous waste regulation. The desired mineral produced would include Pb₅(P0₄)₃Cl (chloropyromorphite), calcium complexed phosphorus, Pb₃(P0₄)₂ (lead phosphate), lead silicates, corkite, plumbogummite, and other relatively insoluble lead minerals, zinc phosphate, copper phosphate, ferric arsenate, cadmium phosphate. The invention provides a means to control heavy metal solubility both under TCLP testing for hazardous waste classification as well as heavy metal bioavailability and solubility in the open environment at an affordable price.

In a preferred embodiment, the compositions and methods of the invention can be used in situ to stabilize heavy metal in lead mining waste and heavy metal ore at mining sites and at transport areas, such as roads and railways prior to smelting. The invention provides the advantages that the heavy metal ore at the mining site can be treated in a manner that allows the heavy metal stabilizing agent to penetrate the cracks and crevasses of the ore, to provide better coverage and hence reduce heavy metal leaching therefrom into the environment surrounding the mining site.

### DETAILED DESCRIPTION OF THE INVENTION

A description of preferred embodiments of the invention follows.

This invention relates to the method of forming highly insoluble heavy metal minerals on the surface of heavy metal bearing materials or waste to reduce the leaching of heavy metal therefrom when the heavy metal bearing material or waste is exposed to leaching conditions. The term “leaching or leachable conditions” used herein means any natural or induced condition that causes heavy metal to solubilize and be removed from the heavy metal bearing material or waste with the mineral stabilizing agents. Formation of insoluble heavy metal minerals upon the surface of the heavy metal bearing material or waste will stabilize the heavy metal such that its leachability, under natural or induced leaching conditions, is reduced compared to its untreated form. A reduction in leaching can be assessed by any natural or induced leach test conditions such as, but not limited to TCLP (Method 1311), Simulated Precipitant Leaching Procedure (SPLP-Method 1310 which simulates rainwater leaching), Japan DI (uses acid adjusted DI water for 6 hours to simulate rainwater leaching), Swiss sequential DI (uses sequential DI water leaching to simulate rainwater), rainwater and other related leaching of heavy metal from the surface of the heavy metal bearing material or waste treated according to the method.

An advantage of the invention is that the bioavailablity of the heavy metal is reduced, upon exposure to the stomach acids of animals, humans or other biological exposures. The term “bioavailability” is intended to mean herein the form of heavy metal that is hazardous to humans, animals and plants, and can be assessed, for example in animals by studying metal uptake in kidneys and other organs.

The term “stabilization” is herein defined as any reduction in the leachable levels of heavy metal from the surface of the heavy metal bearing material or waste, where the reduction is compared to its untreated counterpart. The confirmation of heavy metal surface leaching reduction can be determined by performing a suitable leaching test on the heavy metal bearing material or waste or material that has been in contact as well as physical evaluations of mineral formation under selective electron microscopy (SEM) and/or x-ray diffraction (XRD) techniques.

Material or waste stabilization is herein defined as reducing the leaching of heavy metal from a heavy metal bearing material or waste, as determined by performing a suitable leach test on the material or waste. It should be recognized that the heavy metal bearing material need not be a waste but can be any material containing heavy metal in which it is desirable to stabilize the heavy metal therein. The material can ultimately become waste. Wastes suitable for stabilization, according to the method of invention, typically include solids in waste streams (i.e., a material in liquid or dry form from industrial processing that is commonly subjected to waste disposal), waste piles and material that will be further processed from one waste form to another. In a waste stream, the solid waste can optionally be entrained in a liquid or a gas. Examples of heavy metal bearing materials and wastes which can be stabilized include material and wastes from mining ore, smelting, mining tailings, auto shredders' fluff, wire chop, electroplating processes, arc dust collectors, cupola metal furnaces, sand blasting, sewage sludge drying beds, heavy metal contaminated soil, sweat furnace and incinerator ash. Additional examples of wastes suitable for stabilization include residues and products of the combustion, or partial combustion, of medical waste, commercial waste, industrial waste, sewage sludge and solid municipal waste. This method can also be used to stabilize foundry sand.

In a particular embodiment, the material or waste to be treated is mining waste. The invention pertains to a method of reducing the leaching of lead, arsenic, copper and zinc from heavy metal ore, comprising contacting mining ore waste with at least one wet process phosphoric acid, further comprising a complexing agent and still further comprising surfactant, in an amount effective in reducing the leaching of As, Pb, Cu and Zn from the heavy metal ore, under natural or induced leaching conditions. Mining waste provides a unique problem in that the lead, arsenic, copper or zinc contained in the ore is homogenous throughout, rather than just on the surface of a heavy metal containing waste (commonly known as the halo effect). Ore contains cracks and crevasses that increase the surface area for lead leaching to the environment. Further, due to the vast amounts of ore at mining sites, it is impractical to remove the ore to a landfill. Thus, in situ treatment of mining waste is essential to ensure that leachable contact surfaces be adequately treated to protect the environment surrounding the ore mines. For this embodiment, adequate coverage of the ore surface can be facilitated by incorporation of a surfactant into the phosphate or phosphoric acid composition of the invention. The surfactant improves the material handling of the phosphoric acid or phosphate composition by thinning it into a consistency that facilitates spraying onto the ore. This is particularly useful for amber phosphoric acid as it tends to be viscous. The surfactant can be added directly into the phosphoric acid without negatively impacting the heavy metal complexing properties of the phosphoric acid. However, the incorporation of surfactant into the phosphoric acid composition allows the phosphoric acid composition to improve the ore's affinity for adherence with the phosphoric acid. This is desirable as heavy metal ore tends to be very dry and repels aqueous acid solutions. A particularly preferred surfactant is Tergitol from Union Carbide, although any surfactant can be used.

Leach test conditions, as defined herein, include the conditions to which a material or soil is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract TCLP (fluid number 1) solution is made up from 5.7 ml of glacial acetic acid and 64.3 ml of 1.0 normal sodium hydroxide up to 1000 ml dilution with reagent water. SPLC uses the same tumbling as TCLP, but replaces acetic acid with simulated acid rain (e.g., a solution of carboxyl acid to pH 5.8 east of the Mississippi river and pH 5.9 west of the Mississippi river).

Suitable water leach tests include the Japanese leach test which tumbles 50 grams of composited soil sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached heavy metal is then analyzed by Inductively-Coupled Plasma (ICP) after filtration of a 100 ml aliquot from the tumbler through a 0.45 micron glass bead filter. A WET result of ≧5 ppm lead, 1 ppm Cd, 25 ppm Cu and 250 ppm Zn will be considered hazardous in California.

According to the methods of the invention, leachable heavy metal at the surface of a heavy metal bearing material or waste can be stabilized by contacting it with at least one wet process phosphoric acid at sufficient dosage and duration to allow for substitution and precipitation of relatively soluble heavy metal to relatively insoluble heavy metal minerals. The amount of wet process phosphate incorporated within and/or upon the heavy metal bearing material or waste surface will be that which is effective in reducing the leaching of heavy metal from its surface as needed, for example to a level no more than 5.0 ppm lead, as determined in an EPA TCLP test performed on the waste or material as set forth in the Federal Register, Vol. 55, No. 126; pp. 26985-26998 (Jun. 29, 1990), or other leaching test. In another embodiment, the level will be reduced to no more than 50 ppb as determined by the Simulated Precipitant Leaching Procedure method 1310 or other water leaching test.

The heavy metal stabilizing agent can be incorporated or applied onto the heavy metal bearing material or surface by bath contact, spray, or other surface application means.

The invention provides the use of engineered phosphates such as wet process amber phosphoric acid, green phosphoric acid, merchant grade phosphoric acid, and combinations thereof. Such acids comprise sulfuric acid, vanadium, iron, aluminum and other complexing agents that work with the phosphates to produce water insoluble minerals. It is noted that wet process phosphoric acids may or may not contain calcium depending upon the nature and manufacturing conditions by which the wet process phosphoric acid is made. When calcium is present, additional calcium may not be needed and thus the reaction is considered to be “in the presence” of calcium. The term “wet process amber phosphoric acid” refers to phosphoric acid formed by acidolation of phosphate rock ore with sulfuric acid. The term “green phosphoric acid” refers to phosphoric acid formed by calcined ore acidolated with sulfuric acid. Applicant's discovery of the chemical nature of these wet process fertilizer grade phosphates has made it possible to reduce heavy metal leaching in a one step process. This discovery provides an advantage over Applicant's earlier method from a cost perspective and phosphate availability. See U.S. Pat. No. 5,722,928 issued to Forrester which teaches the use of technical grade phosphoric acid and phosphates in the presence of complex agents for mineral formations of heavy metal bearing wastes.

The size, dose rate, mineral formation contact duration, application, and phosphate stabilizer contact means, could be engineered for each type of heavy metal bearing material or waste and contact method employed. When heavy metal comes into contact with the stabilizing agent, low water soluble compound(s) begin to form, typically a mineral phosphate or precipitate formed through substitution or surface bonding, which is less soluble than the heavy metal originally in the material or waste to be treated. For example, the mineral apatite lead phosphate Ca₄(Pb)(P0₄)₃ OH, lead phosphate Pb₃(P0₄)₂, lead silicate Pb₂(Si0₃), lead sulfide PbS, chloropyromorphite Pb₅(PO₄)Cl, corkite, plumbogummite, zinc phosphate, copper phosphate, cadmium phosphate and ferric arsenate can be formed by adding respective precipitating agents with complex sources, to the heavy metal surface at standard temperature and pressure.

It is understood that the wet process phosphoric acid, complexing agent and surfactant can be added to the material or waste either separately, concurrently, in combination, sequentially, intermittently, or in any other sequence or order. It is also understood that the wet process phosphoric acid and/or complexing agent and/or surfactant can be added to the material or waste as solids, in aqueous solution or in a slurry. Furthermore, the wet process phosphoric acid, complexing agent and surfactant can be contacted with the material or waste without mixing, or optionally, with mixing.

It also remains possible that modifications to reactor temperature and pressure (preferably under standard temperature and pressure conditions) may accelerate or assist formation of heavy metal minerals, although such methods are not considered optimal for this application given the need to limit cost and provide for optional field based heavy metal stabilizing operations that would be complicated by the need for pressure and temperature control devices and vessels.

In another method, the heavy metal bearing material or waste is contacted with the wet process phosphate and the complex source in the presence of a surfactant to facilitate the material handling of the compositions of the invention, such as described above for the mining embodiment. The surfactant is preferably Tergitol™ from Union Carbide. Other wastes would include piled industrial waste, roadway and railway soils.

In another embodiment, particularly for reducing arsenic leaching and lead or other heavy metal leaching, the material or waste is pretreated with a complexing agent (e.g., ferric chloride) for a period of time sufficient to form a mineral complex (e.g., ferric arsenate). The pretreated material or waste is then treated with the wet process phosphoric acid. See Table 5.

The amounts of the wet process phosphate and complexing agent used, according to the method of invention, depend on various factors including character of the material or waste to be treated, desired heavy metal solubility reduction potential, desired heavy metal mineral toxicity, and desired lead mineral formation relating to toxicological and site environmental control objectives. It has been found that an amount of certain stabilizing agents such as amber wet process phosphoric acid and calcium chloride solution, equivalent to between about 0.1% and about 2.0% by weight acid and 0.1 to 0.5% CaCl₂ of the material or waste is sufficient for initial TCLP stabilization. However, the foregoing is not intended to preclude yet higher or lower usage of stabilizing agent or combinations if needed since it has been demonstrated that amounts greater than 0.5% by weight also work, but are more costly. Typically, the minimum concentrations of phosphate and complexing agent in a treated heavy metal bearing material or waste, which are needed to stabilize said material or waste, are about 0.5 weight percent phosphate and about 0.10 weight percent complexing agent, under water leaching conditions.

In this method, the phosphate and complexing source can be applied during waste generation, applied to waste contained in a waste stream and/or applied to waste stored in a waste pile. In one embodiment, a phosphate and complexing agent are added to the source of a heavy metal bearing waste prior to generating said heavy metal bearing waste. For example, phosphate and complexing agent can be sprayed, coated, added, mixed or otherwise contacted with copper wire insulation before chopping the copper wire, thereby producing a stabilized lead, copper and zinc bearing waste.

In another embodiment, phosphate and complexing agent are coated onto equipment which produces the material or waste. For example, phosphate and complexing agent can be sprayed, coated or otherwise contacted with wire chopping equipment, prior to, or during operation. This enables one to stabilize lead, copper and zinc in situ or in-line.

In yet another embodiment, phosphate and complexing source are contacted with waste contained in a waste stream, typically without restricting the free flow of the waste stream. For example, phosphate and complex source can be directed onto or into waste in a free flowing waste stream by injection, spraying, coating or other suitable means. Alternatively, phosphate and complexing source can be coated onto equipment which directs and/or transports waste in a waste stream. For example, phosphate and complexing source can be sprayed, coated or otherwise contacted with equipment for conveying wire chop waste, such as a screw conveyor, prior to or during equipment operation. Further, for incinerator units, a phosphate and complexing source can be sprayed, coated or otherwise contacted with gas/solid separators, for separating solids from combustion gases, such as cyclone separators or vortex separators, thereby treating the solid waste while separating the solid waste from the gaseous waste product.

In a further embodiment, phosphate and complexing source can be contacted with waste contained in a waste pile. Typically, the phosphate and complexing source are added to the surface of the waste pile. Optionally, the phosphate and the complex source are directed into the waste pile. Suitable means for directing the phosphate and complex source into the waste pile include, for instance, tilling and/or irrigation with surface or subsurface water sprays or water injection. If mixing through tilling, the phosphate and complex source are usually mixed into the waste pile to a depth of about one to three feet.

The examples below are merely illustrative of this invention and are not intended to limit the invention in any way.

### EXAMPLE 1

TABLE 1

| Formulation | TCLP Pb (ppm) | DI Pb (ppm) |
|---|---|---|
| Demolition Soil Baseline | 130 | 13.3 |
| 1% Green phosphoric acid | 34 | 1.23 |
| 1% Green phosphoric acid + | 16.3 | 0.34 |
| 0.001% Surfactant | | |
| 1% Amber phosphoric | 14.6 | 0.89 |
| acid | | |
| 1% Amber phosphoric | 1.7 | 0.05 |
| acid + 0.001% Surfactant | | |

The green phosphoric acid was from J.R. Simplot Company (Pocatello, Id.) and the amber phosphoric acid was from PCS Phosphate (Geismar, La.). The surfactant sample was Tergitol D-683 from Union Carbide.

### EXAMPLE 2

TABLE 2

| Formulation | TCLP Pb (ppm) | DI Pb (ppm) | Extract pH |
|---|---|---|---|
| Lead Mining Ore Spillage | 19 | 0.02 | 6.1 |
| 1% Amber Wet | 2.6 | <0.01 | 5.4 |
| Phosphoric Acid | | | |
| 1% Amber + 0.05% NS | 0.9 | <0.01 | 5.4 |
| 1% Amber + 0.32% CaCl | 0.9 | <0.01 | 5.4 |

The amber phosphoric acid was from PCS Phosphate (Geismar, La.). Sodium silicate (NS) and calcium chloride were from Dow Chemical. Twenty-four hour curing time allowed for all stabilized samples. All percentages wwb addition to ore sample.

TABLE 3

| Pb/Zn Mining Tailings | DI Pb (ppm) | DI Zn (ppm) |
|---|---|---|
| Baseline | 0.70 | 1.50 |
| 1% Amber Phosphoric Acid | <0.05 | <0.05 |
| 1% Amber/0.1% NS | <0.05 | <0.05 |
| 0.5% CP/0.1% NS | <0.05 | <0.05 |

* CP = monocalcium phosphate from PCS Phosphate supply

TABLE 4

| Pb/Zn/Cd Mining Tailings | DI Pb/Zn/Cd (ppm) |
|---|---|
| Baseline | 0.10/3.0/0.50 |
| 0.5% Amber Phosphoric Acid | <0.05/0.17/0.05 |
| 0.5% Amber/0.1% NS | <0.05/<0.05/<0.05 |
| 0.5% Amber/0.05% CaO | <0.05/<0.05/<0.05 |

CaO = dolomitic lime #16 sieve pass 100%

TABLE 5

| Smelter Ash/Slag | TCLP Pb/As (ppm) |
|---|---|
| Baseline | 57.0/674 |
| 1% Amber Phosphoric Acid | 1.7/250 |
| 2% Ferric Chloride (FC) | 45.6/14.5 |
| *2% FC + 1% Amber Phosphoric Acid | 0.9/3.7 |
| | (RCRA limit 5.0/5.0) |

*2% FC applied alone first with 1 hour cure prior to 1% Amber Phosphoric Acid addition

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of reducing the leaching of heavy metal from the surface of a heavy metal bearing material or waste, comprising contacting heavy metal bearing material or waste surface with at least one wet process phosphoric acid, in an amount effective in reducing the leaching of heavy metal from heavy metal bearing material or waste surface to a level no more than RCRA HAZ as determined in an EPA TCLP test, said test performed on the heavy metal bearing material or waste impact area, heavy metal contaminated soils or heavy metal contaminated material receiving the heavy metal bearing material or waste, as set forth in the Federal Register, vol. 55, no. 126, pp. 26985-26998 (Jun. 29, 1990).

2. The method of claim 1, wherein the phosphate is merchant grade phosphoric acid.

3. The method of claim 1, wherein the phosphate is amber phosphoric acid.

4. The method of claim 1, wherein the phosphate is green phosphoric acid.

5. The method of claim 1 further comprising a complexing agent.

6. The method of claim 5, wherein the complexing agent is calcium chloride.

7. The method of claim 1 further comprising a surfactant.

8. A method of reducing the leaching of heavy metal from the surface of a heavy metal bearing material or waste, comprising contacting heavy metal bearing material or waste surface with at least one wet process phosphoric acid, in an amount effective in reducing the leaching of lead from lead bearing material or waste surface under natural or induced lead leaching conditions.

9. The method of claim 8 further comprising a complexing agent.

10. The method of claim 8 further comprising a surfactant.

11. A method of reducing the leaching of heavy metal from the surface of a heavy metal bearing material or waste, comprising contacting heavy metal bearing material or waste surface with at least one wet process phosphoric acid in an amount effective in reducing the leaching of heavy metal from heavy metal bearing material or waste surface, to a level of Groundwater, Surface Water or Drinking Water Standards as determined by Simulated Precipitant Leaching Procedure method 1310 or water leach test.

12. The method of claim 11 further comprising a complexing agent.

13. The method of claim 11 further comprising a surfactant.

14. A method of reducing the leaching of heavy metal from heavy metal mining waste ore tailings, comprising contacting heavy metal ore with at least one wet process phosphoric acid, in an amount effective in reducing the leaching of heavy metal from the heavy metal ore to a level no more than RCRA HAZ as determined in an EPA TCLP test, said test performed on the heavy metal ore impact area, heavy metal contaminated soils or heavy metal contaminated material receiving the heavy metal bearing material or waste, as set forth in the Federal Register, vol. 55, no. 126, pp. 26985-26998 (Jun. 29, 1990).

15. The method of claim 14, wherein the phosphate is merchant grade phosphoric acid.

16. The method of claim 14, wherein the phosphate is amber phosphoric acid.

17. The method of claim 14, wherein the phosphate is green phosphoric acid.

18. The method of claim 14 further comprising a complexing agent.

19. The method of claim 18, wherein the complexing agent is calcium chloride.

20. The method of claim 14 further comprising a surfactant.

21. A method of reducing the leaching of heavy metal from the surface of a heavy metal bearing material or waste, comprising contacting heavy metal bearing material or waste surface with at least one wet process phosphoric acid and complexing agent, in an amount effective in reducing the leaching of lead from lead bearing material or waste surface under natural or induced lead leaching conditions.

22. A method of reducing the leaching of heavy metal from heavy metal mining waste ore tailings, comprising contacting heavy metal ore with at least one wet process phosphoric acid, complexing agent and surfactant, in an amount effective in reducing the leaching of heavy metal from the heavy metal ore to a level no more than RCRA HAZ as determined in an EPA TCLP test, said test performed on the heavy metal ore impact area, heavy metal contaminated soils or heavy metal contaminated material receiving the heavy metal bearing material or waste, as set forth in the Federal Register, vol. 55, no. 126, pp. 26985-26998 (Jun. 29, 1990).
